(19) United States
(12) Patent Application Publication
(10) Pub. No.: US 2003/0115471 A1
(43) Pub. Date: Jun. 19, 2003

(54) Method and apparatus for building operational radio firmware using incrementally certified modules

(76) Inventor: Kirk W. Skeba, Fremont, CA (US)

Correspondence Address: John Patrick Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/028,467

(22) Filed: Dec. 19, 2001

(51) Int. Cl. H04L 9/00

(52) U.S. Cl. 713/180

(57) ABSTRACT

According to one aspect of the invention, a method is disclosed. The method comprises generating an asymmetric cryptographic key pair comprising first and second keys; encrypting a boot loader program for a baseband module with said first key; storing said second key in said baseband module; and distributing said encrypted boot loader program together with said second key.

### FIELD OF THE INVENTION

The present invention relates to the certification of radio protocols. In particular it relates to the certification of radio protocols in radio devices wherein said protocols may be updated or changed.

### BACKGROUND

Traditionally, a radio transmitter is approved for a specific set of technical parameters including operating frequencies, power output, and types of radio frequency emissions. Under current Federal Communication Commission (FCC) rules, if a manufacturer of a radio transmitter changes these parameters after a transmitter has been authorized for use by the FCC, then the manufacturer must apply for a new certificate. With emerging wireless standards that occupy the Industrial, Scientific and Medical (ISM) frequency bands, it is becoming more attractive to provide a single device that accommodates multiple radio protocols or capabilities. Providing configurable radios with varying capabilities makes the certification process within the current FCC approval cycle difficult. Further, a modern manufacturing trend is to partition components of a radio and to allow different manufacturers access to these partitioned components to configure them. Without a scheme which satisfies the FCC that steps have been taken which would insure proper configuration of such radios, FCC certification would be required each time a partitioned component is reconfigured.

### BRIEF DESCRIPTION OF THE DRAWINGS

FIG. 1 shows a block diagram of one embodiment of a system comprising a radio in accordance with the invention;

FIG. 2 shows a block diagram of a radio unit forming part of the system of FIG. 1;

FIG. 3 shows a flowchart of operations performed by a manufacturer of the radio of FIG. 1 according to one embodiment of the invention;

FIG. 4 shows a flowchart of operations by a vendor prior to reselling the radio of FIG. 1, according to one embodiment of the invention;

FIG. 5 shows a flowchart of operations performed by a vendor to upgrade a radio protocol of the radio of FIG. 1, according to one embodiment of the invention; and

FIG. 6 shows a flowchart of operations performed by a user of the radio of FIG. 1 in order to change a radio protocol in accordance with one embodiment of the invention.

### DETAILED DESCRIPTION

The invention allows multiple pre-certified software radio modules to be combined in a manner so as not to lose FCC certification integrity. In accordance with embodiments of the invention there is provided a method of certifying hardware components with a specific radio protocol or personality and then incrementally adding other certified personalities to build a fully authenticated operational multi-personality radio while maintaining FCC certification.

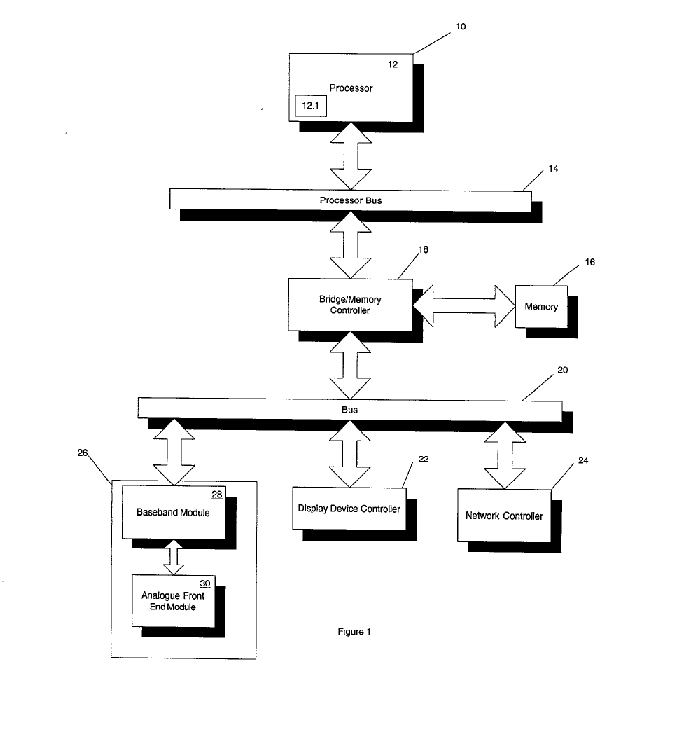

FIG. 1 of the drawings shows a block diagram of one embodiment of a system 10 comprising a radio device in accordance with one embodiment of the invention. Referring to FIG. 1, the system 10 includes a processor 12 that processes data signals. Processor 12 may be a Complex Instruction Set Computer (CISC) microprocessor, a Reduced Instruction Set Computing (RISC) microprocessor, a Very Long Instruction Word (VLIW) microprocessor, a processor implementing a combination of instructions sets, or any other processor device. In one embodiment, processor 12 is a processor in a Pentium® family of processors including the Pentium® 4 family and mobile Pentium® and Pentium® 4 processors available from Intel Corporation of Santa Clara, Calif. Alternatively, other processors may be used. FIG. 1 shows an example of a computer system 10 employing a single processor computer. However, one of ordinary skill in the art will appreciate that computer system 10 may be implemented using multiple processors.

Processor 12 is coupled to a processor bus 14. Processor bus 14 transmits data signals between processor 12 and other components in system 10. System 10 further includes a memory 16. In one embodiment, memory 16 is a Dynamic Random Access Memory (DRAM) device. However, in other embodiments, memory 16 may be a Static Random Access Memory (SRAM) device, or other memory device.

Memory 16 may store instructions and code represented by data signals that are be executed by processor 12. According to one embodiment, a cache memory 12.1 resides within processor 12 and stores data signals that are also stored in memory 16. Cache 12.1 speeds up memory accesses by processor 12 by taking advantage of its proximity to processor 12. In another embodiment, cache 12.1 resides external to processor 12.

System 10 further includes a bridge memory controller 18 coupled to processor bus 14 and memory 16. Bridge/memory controller 18 directs data signals between processor 12, memory 16, and other components in system 10 and bridges the data signals between processor bus 14, memory 16, and a first input/output (I/O) bus 20. In one embodiment, I/O bus 20 may be a single bus or a combination of multiple buses.

In a further embodiment, I/O bus 20 may be a Peripheral Component Interconnect adhering to a Specification Revision 2.1 bus developed by PCI Special Interest Group of Portland, Oreg. in another embodiment, I/O bus 20 may be a Personal Computer Memory Card International Association (PCMCIA) bus developed by the PCMCIA of San Jose, Calif. Alternatively, other buses may be used to implement I/O bus. I/O bus 20 provides communications links between components in system 10.

A display device controller 22 is coupled to I/O bus 20. Display device controller 22 allows coupling of a display device to system 10 and acts as interface between the display device and system 10. In one embodiment, display device controller 22 is a Monochrome Display Adapter (MDA) card. In other embodiments, display device controller 22 maybe a Color Graphics Adapter (CGA) card, Enhance Graphic Adapter (EGA) card, an Extended Graphics Array (XGA) card, or other display device controller. A display device may be a television set, a computer monitor, a flat panel display or other display device. The display device receives data signals from processor 12 through display device controller 22 and displays the information and data signals to a user of system 10.

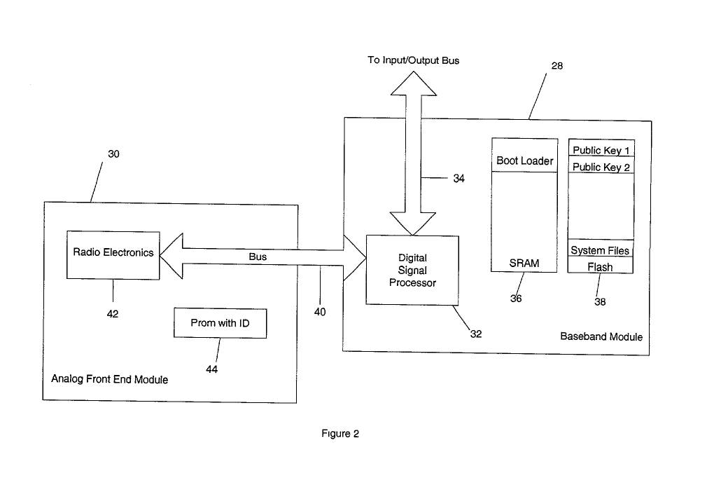

The system 10 further includes a network controller 24 which is coupled to I/O bus 20. Network controller 24 links system 10 to a network of computers (not shown in FIG. 2 of the drawings) and supports communications between the computers. According to one embodiment of the invention, network controller 24 enables system 10 to access a server in order to download a radio protocol.

The system 10 further includes a radio device 26 which is coupled to the I/O bus 20. The radio device 26 comprises a baseband module 28 and an analog front-end (AFE) module 30. The radio device 26 is shown in greater detail in FIG. 2 of the drawings. Referring to FIG. 2 of the drawings, it will be seen that the baseband module 28 includes at least one digital signal processor (DSP) 32 which is connected via a bus 34 to I/O bus 20. The DSP 32 processes instructions and data received by baseband module 28. The DSP 32 integrates a processor core, a program memory device, and application specific circuitry on a single integrated circuit. One of ordinary skill in the art will appreciate that each of the DSPs may be replaced with other components (e.g. Field Programmable Arrays (FPGAs) without departing from the scope of the invention). The baseband module 28 further includes a volatile memory device 36 which stores instructions and code represented by data signals that are executed by DSP 32. According to one embodiment, memory device 36 is Static Random Access Memory (SRAM) device. However, one of ordinary skill in the art will appreciate that other types of volatile memory devices may be implemented.

The baseband module 36 further includes a non-volatile memory 38 which stores instructions and code that is executed by DSP 30. In addition, nonvolatile memory 38 stores programs that are important to DSP 30. In one embodiment, memory 38 is a Programmable Read Only Memory (PROM). However, memory 38 may be implemented using other non-volatile memory devices.

Baseband module 28 is coupled to AFE module 30 via bus 40. In one embodiment, the bus 40 may be a high-speed radio interface bus. However, one of ordinary skill in the art will recognize that other types of buses may be used. The AFE module 30 includes radio electronics 42 which for the sake of simplicity have not been set out in detail. However, one skilled in the art will understand that radio electronics 40 will necessarily include frequency co.nversion logic, analog-to-digital/digital-to-analog sampling logic and frequency or synthesis circuits. Likewise, components such as embedded controller support blocks, clocks, interface logic and miscellaneous hardware acceleration blocks required by a radio protocol have been excluded from the description of baseband module 28, but will be recognized to form part of baseband module 28 by one skilled in the art.

The AFE module 30 further includes a non-volatile memory device 44 which stores an AFE identification (ID). The AFE ID is a cryptographic key that is used to provide authentication that AFE module 44 has been certified by the FCC to operate with baseband module 28. In one embodiment, memory 44 is a programmable read-only memory (PROM). However, memory 44 may be implemented using other non-volatile memory devices.

According to one embodiment, AFE module 30 may be implemented using one of a plurality of analog radio devices. For instance, AFE module 28 may be implemented with a 2.4 or 5.1 gigahertz radio, as well as radios operating at other frequencies.

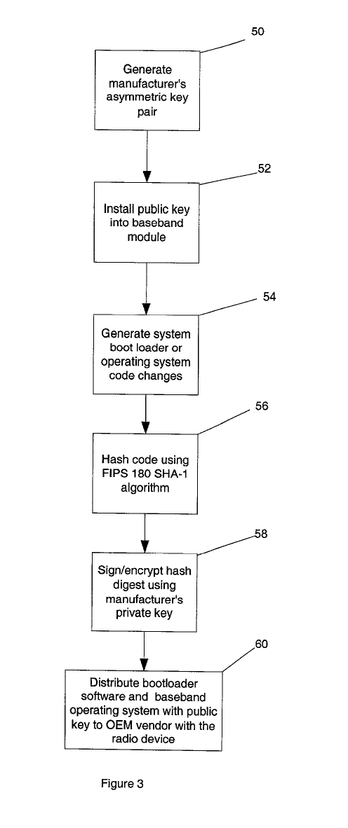

FIG. 3 of the drawings shows a flowchart of operations performed by a manufacturer of radio device 26, in accordance with one embodiment of the invention. Referring to FIG. 3 at block 50 the manufacturer generates an asymmetric cryptographic key pair comprising a public key and a private key. At block 52 the manufacturer installs the public key into baseband module 28. This is referred to public key 1 in FIG. 2 of the drawings. At block 54 a manufacturer generates a system boot loader or operating system code changes At block 56 the boot loader code is hashed using a hashing algorithm for example, the algorithm known as FIPS 180 SHA-1. Naturally, other algorithms may also be used. At block 58 a hash digest is generated using the manufacturer's private key. At block 60 the manufacturer distributes the boot loader code and the operating system for baseband unit 26 together with the public key to an Original Equipment Manufacturer (OEM) vender together with the radio device 26. By performing the operations shown in FIG. 3 of the drawings, a manufacturer of the radio device 26 provides an encrypted boot loader program to an OEM vendor which program may be used to access memory device 38 of the baseband module 36 for purposes of loading a radio protocol therein. By performing the operations shown in FIG. 3 of the drawings, a manufacturer provides sufficient guarantees to the FCC that an unauthorized radio protocol may not be downloaded and stored in memory device 38 of the baseband module 28.

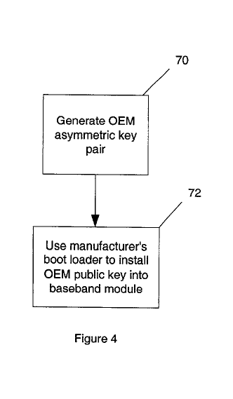

FIG. 4 of the drawings shows a flowchart of operations performed by an OEM vendor. At block 70, the OEM vendor generates an asymmetric key pair comprising a public key and a private key. At block 72 the OEM vendor uses the manufacturers boot loader program to install an OEM public key into baseband module 28. This public key is referred to as public key 2 in FIG. 2 of the drawings.

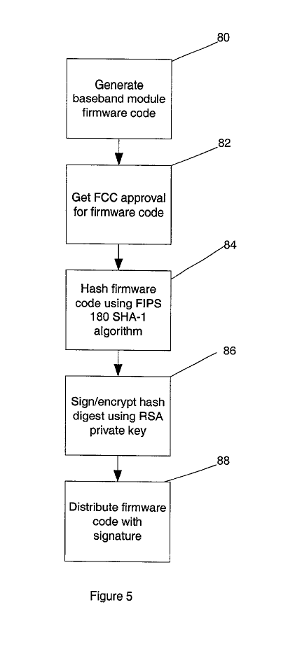

FIG. 5 of drawings shows a flow chart of operations performed by the OEM vendor once the operations shown in FIG. 4 of the drawings have been completed. Referring to FIG. 5 of the drawings, at block 80 the OEM vendor generates firmware code for the baseband module 28. This firmware code may be an upgrade to an existing radio protocol or may comprise an entirely new/emerging radio protocol. At block 82 the OEM vendor obtains FCC approval for said firmware code. At block 84, once the approval has been obtained, the firmware code is hashed using any suitable hashing algorithm for example, FIPS 180 SHA-1. At block 86 the OEM vendor generates a hash digest for said firmware code using the private key, which in this example is an RSA private key. Finally at bock 88, the OEM vendor distributes the firmware code together with the digital signature generated therefor. The distribution of the firmware code may be achieved by distributing storage media including said code. Alternatively, the distribution may be achieved by providing a website with links to download said firmware code.

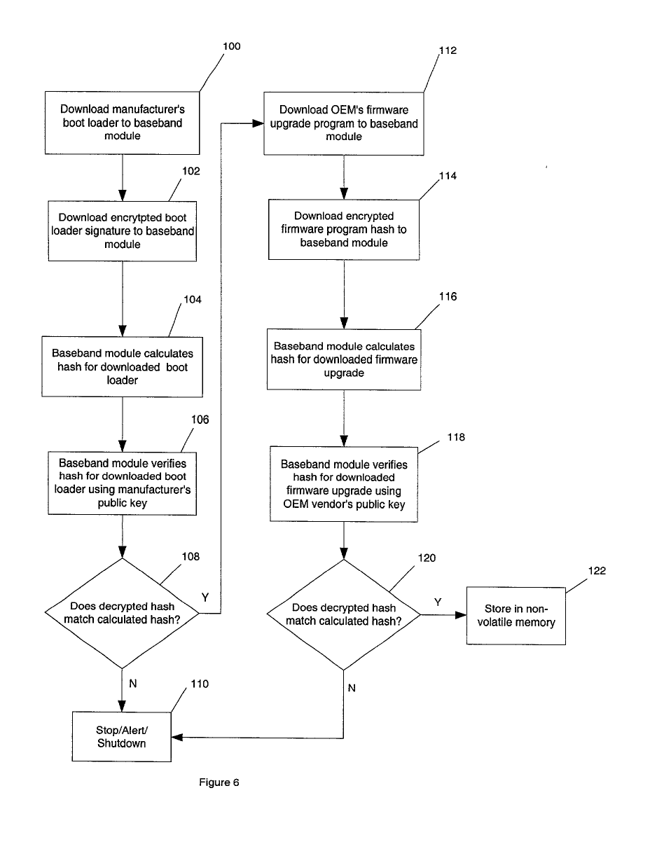

FIG. 6 shows a flowchart of operations performed by a user of system 10 in order to change/upgrade a radio protocol for said radio device 26. Referring to FIG. 6, at block 100 the user downloads the manufacturer's boot loader program to the baseband module 28. Although FIG. 6 refers to downloading the manufacturer's boot loader, it will be appreciated that the boot loader may be loaded from some storage medium such as a CD ROM or a floppy diskette. At block 102 the user downloads the encrypted boot loader signature to baseband module 28. At block 106 baseband module 28 calculates a hash key for the downloaded boot loader. At 106 baseband module 28 verifies the hash key for the downloaded boot loader using the manufacturer's public key i.e. public key 1. At block 108 a match is done between the decrypted hash and the calculated hash. If there is no match then at block 110 system 10 shuts down or alerts the user. If there is a match then at 112 the OEM vendor's firmware upgrade program is downloaded to baseband module 28. At block 114 the encrypted firmware program hash key is downloaded to baseband module 28. At block 116 the baseband module calculates a hash for the downloaded firmware upgrade. At block 118 the baseband module 28 verifies the hash key for the downloaded firmware upgrade using the OEM vendors public key, i.e. public key 2. At block 120 a match is performed between the decrypted hash key and the calculated hash key. If there is not match then at block 110 system 10 is shutdown or the user is alerted. If there is a match then at block 122 the downloaded firmware program is stored in non-volatile memory device 38. The operations shown in FIG. 6 of the drawings are performed once for each new radio protocol or software upgrade. Thereafter, the radio protocol is installed in non-volatile memory device 38. This provides the benefit of eliminating long start-up times associated with downloading and authenticating radio protocols each time system 10 is powered up.

One advantage of the present invention is that is provides a mechanism to certify hardware components with a specific radio protocol personality and to incrementally add other certified radio protocols to build a fully authenticated operational multi-personality radio in accordance with FCC certification. This allows the life cycle of existing hardware platforms to be extended as it provides a mechanism to implement new or emerging radio protocols without having to change the hardware.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

What is claimed is:

1. A method comprising:
generating an asymmetric cryptographic key pair comprising first and second keys;
encrypting a boot loader program for a baseband module with said first key;
storing said second key in said baseband module; and
distributing said encrypted boot loader program together with said second key.

2. The method of claim 1, wherein encrypting said boot loader program comprises generating a message digest for said boot loader program and encrypting said message digest with said first key.

3. The method of claim 1, wherein said first key is a private key and said second key is a public key.

4. A method comprising:
receiving a radio protocol at a baseband module;
determining whether said radio protocol has been certified by a certification authority; and
storing said radio protocol in a non-volatile memory device in said baseband module, if said radio protocol has been certified by said certification authority.

5. The method of claim 4, wherein determining whether said radio protocol has been certified comprises authenticating said radio protocol using a first cryptographic key stored in said baseband module.

6. The method of claim 5, wherein said first cryptographic key is a public key.

7. The method of claim 3, wherein said storing said radio protocol comprises using a boot loader program to write said radio protocol to said non-volatile memory device.

8. The method of claim 7, further comprising determining whether said boot loader program has been approved by a manufacturer of said baseband module.

9. The method of claim 8, wherein determining whether said boot loader program has been approved by said manufacturer comprises authenticating said program using a second cryptographic key stored in said baseband module.

10. The method of claim 9, wherein said second cryptographic key is a public key.

11. A method comprising:
generating an asymmetric cryptographic key pair comprising first and second keys;
storing said second key in a non-volatile memory device in a baseband module;
encrypting a radio protocol with said first key, said protocol having been certified by a certification authority; and
distributing said encrypted radio protocol.

12. The method of claim 11, wherein storing said second key comprises authenticating a previously distributed boot loader program which controls access to said non volatile memory device; and using said authenticated boot loader program to write said second key to said non-volatile memory device.

13. The method of claim 12, wherein authenticating said previously distributed boot loader program comprises using a third cryptographic key stored in said baseband module by a manufacturer thereof.

14. The method of claim 12, wherein said first key is a private key and said second key is a public key.

15. The method of claim 11, wherein everything said radio protocol comprises generating a message digest for said radio protocol and encrypting said message digest with said first key.

16. Apparatus comprising:
a receiver to receive a radio protocol;
a mechanism to determine whether said radio protocol has been certified by a certification authority; and
a non-volatile memory device to store said radio protocol if it has been certified by said certification authority.

17. The apparatus of claim 16, wherein said mechanism determines whether said radio protocol has been certified by authenticating said radio protocol using a cryptographic key stored in said baseband module.

18. The apparatus of claim 17, wherein said first cryptographic key is a public key.

19. The apparatus of claim 16, further comprising a boot loader program to write said radio protocol to said non-volatile memory device.

20. The apparatus of claim 19, further comprising a mechanism to determine whether said boot loader program has been approved by a manufacturer of said apparatus.

21. The apparatus of claim 20, wherein said mechanism to determine whether said boot loader program has been approved by a manufacturer of said apparatus authenticates said boot loader program using a second cryptographic key stored in said apparatus.

22. The apparatus of claim 21, wherein said second cryptographic key is a public key.

23. A computer-readable storage medium having stored thereon a sequence of instructions which when executed cause a processor to perform operations comprising:
receiving a radio protocol at a baseband module;
determining whether said radio protocol has been certified by a certification authority; and
storing said radio protocol in a non-volatile memory device in said baseband module, if said radio protocol has been certified by said certification authority.

24. The computer-readable storage medium of claim 23, wherein determining whether said radio protocol has been certified comprises authenticated said radio protocol using a first cryptographic key stored in said baseband module.

25. The computer-readable storage medium of claim 24, wherein said first cryptographic key is a public key.

26. The computer-readable storage medium of claim 23, wherein said storing said radio protocol comprises using a boot loader program to write said radio protocol to said non-volatile memory device.

27. The computer-readable storage medium of claim 26, wherein said operations further comprise determining whether said boot loader program has been approved by a manufacturer of said baseband module.

28. The computer-readable storage medium of claim 27, wherein determining whether said boot loader program has been approved by said manufacturer comprises authenticating said program using a second cryptographic key storing said baseband module.

29. The computer-readable storage medium of claim 27, wherein said second cryptographic key is a public key.

30. Apparatus comprising:
means for receiving a radio protocol;
means for determining whether said radio protocol has been certified by certification authority; and
means for storing said radio protocol if it has been certified by said certification authority in non-volatile memory.

31. The apparatus of claim 9, wherein said means for determining whether said radio protocol has been certified authenticate said radio protocol using a cryptographic key stored in said baseband module.

32. The apparatus of claim 30, wherein said first cryptographic key is a public key.

33. The apparatus of claim 29, further comprising a boot loader means for writing said radio protocol to said memory device.

34. The apparatus of claim 32, further comprising a means for determining whether said boot loader means has been approved by a manufacturer of said apparatus.

35. The apparatus of claim 33, wherein said means for determining whether said boot loader means has been approved by a manufacturer of said apparatus authenticate said boot loader means using a second cryptographic key stored in said apparatus.

36. The apparatus of claim 34, wherein the second cryptographic key is a public key.
